(19) United States
(12) Patent Application Publication
(10) Pub. No.: US 2014/0086816 A1
(43) Pub. Date: Mar. 27, 2014

(54) USE OF BURNERS WITH A JET TUBE IN REACTORS FOR CONVERSION OF CHLOROSILANES

(71) Applicants: Bernd Wehner, Karlstein (DE); Christof Zipper, Rheinfelden (DE); Guido Stochniol, Haltern am See (DE); Ingo Pauli, Schmitten (DE); Norbert Schladerbeck, Kelkheim (DE)

(72) Inventors: Bernd Wehner, Karlstein (DE); Christof Zipper, Rheinfelden (DE); Guido Stochniol, Haltern am See (DE); Ingo Pauli, Schmitten (DE); Norbert Schladerbeck, Kelkheim (DE)

(73) Assignee: Evonik Degussa GmbH, Essen (DE)

(21) Appl. No.: 14/007,495

(22) PCT Filed: Feb. 27, 2012
(86) PCT No.: PCT/EP12/53251

§ 371 Date: Dec. 3, 2013

(30) Foreign Application Priority Data
Mar. 25, 2011 (DE) 10 2011 006 116.9

(51) Int. Cl. C01B 33/107

(52) U.S. Cl. CPC C01B 33/1071
USPC 423/342

(57) ABSTRACT

The invention provides for the use of a particular burner design to heat reactors for conversion of chlorosilanes, wherein the burner has a jet tube and the jet tube surrounds the flame and the flame tube in a gastight manner, as a result of which the combustion air, the gaseous and/or liquid fuels, and also the flue gases cannot get into the reaction furnace space. The advantage is the complete separation of the flue gas from the actual interior of the reaction furnace, which prevents critical interactions between flue gas moisture and chlorosilanes in the case of fracture of the arrangement accommodating the chlorosilanes. This in turn makes it possible to use gaseous or liquid fuels to heat such a reaction furnace. Excessive local input of heat as a result of direct flame contact is prevented; the heat input is homogenized.

The present invention relates to the use of burners with a jet tube to heat a reactor for conversion of chlorosilanes.

The prior art includes heated chemical reactors, for example tubular reactors, which are heated electrically or by means of burners using liquid or gaseous fuels. The burners act directly into the reactor space, in which the devices for accommodation of the chemical substances of the reaction, for example pipe arrangements, are situated. As a result of the heating, the high reaction temperatures required are attained and/or heat losses due to the endothermicity of the processes are compensated.

The substances converted in such chemical reactors are typically conducted in arrangements made of metal or other materials. In the case of highly corrosive substances, ceramic materials may also be employed.

In the event of failure of the arrangements made of metal or other materials which accommodate the chemical substances, these substances come into contact with the flame gases, which can lead to unwanted reactions, some of them exothermic.

There is thus a need for a design for a method of heating a reaction furnace, in which there is heat input with simultaneous media separation. This object is achieved by a combination of burner, flame tube and jet tube, in which the flame gases have no contact whatsoever with the interior of the combustion chamber.

The invention accordingly provides for the use of a burner to heat a reactor for conversion of chlorosilanes, wherein the burner has a jet tube and the jet tube surrounds the flame and the flame tube in a gastight manner, as a result of which the combustion air, the gaseous and/or liquid fuel, and flue gases cannot get into the reaction furnace space.

In the context of the invention, the arrangement of the burner described is referred to as “burner with a jet tube”.

The inventive use of burners with a jet tube has the particular advantage of enabling operationally reliable conversion of chlorosilanes, since contact of flue gases with the reaction gas must absolutely be avoided in reaction furnaces in the case of reaction with chlorosilanes, for example in the case of hydrogenation of chlorosilanes, if the reaction medium escapes into the furnace space as a result of a defect in the accommodating arrangement. In the event of contact of the moisture of the flue gas with chlorosilanes, unwanted reactions of vigorous exothermicity would otherwise occur.

A further advantage of burners with a jet tube is the resultant possibility of economically viable heating of a reaction furnace for conversion of chlorosilanes with a cheaper energy carrier than electricity, without accepting the disadvantage outlined.

Likewise an advantage of the inventive use is the fact that the heat of the reaction is introduced into the reaction furnace and hence into the reaction media very substantially in the form of thermal radiation. This prevents local overheating of internals of the reaction furnace by preventing direct contact with the burner flame. The heating is also very homogeneous.

The arrangement of the burners with a jet tube used in accordance with the invention in the interior of the reaction furnace is as desired, and may involve one or more, suspended from above or mounted in an inverted manner from the bottom, or from the sides of the combustion chamber.

The inventive use is particularly advantageous in the case of reactions with chlorosilanes, particularly in the case of hydrogenation of silicon tetrachloride with hydrogen to give trichlorosilane and hydrogen chloride. The reaction temperatures may attain values up to 1100° C. and pressures up to 50 bar gauge, and the reaction can be operated without or with catalyst.

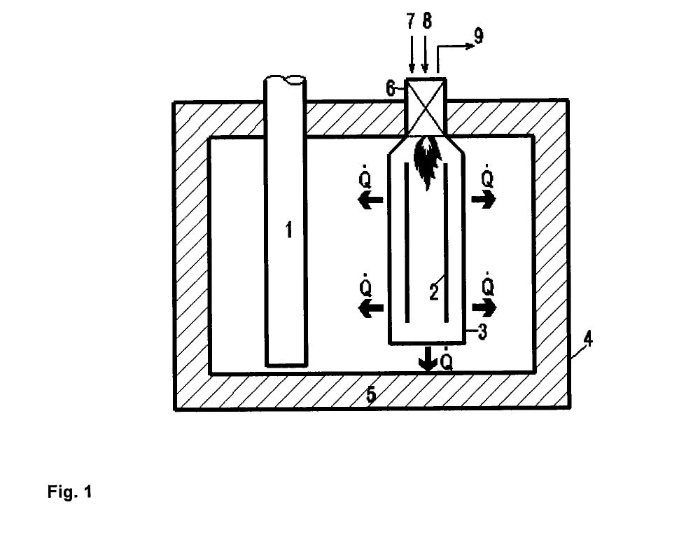

FIG. 1 shows a preferred embodiment of the burner with a jet tube used in accordance with the invention in schematic view.

The reference numerals mean:

1 Arrangement for conduction of chemical reactants

2 Flame tube

3 Jet tube

4 Reaction furnace

5 Insulation

6 Burner

7 Combustion air

8 Fuel

9 Flue gas

\dot{Q} Heat flow

1. Use of a burner to heat a reactor for conversion of chlorosilanes, wherein
the burner has a jet tube and
the jet tube surrounds the flame and the flame tube in a gastight manner, as a result of which
the combustion air, the gaseous and/or liquid fuel, and flue gases cannot get into the reaction furnace space.
